(19) United States
(12) Patent Application Publication
(10) Pub. No.: US 2023/0322260 A1
(43) Pub. Date: Oct. 12, 2023

(54) SYSTEMS AND METHODS FOR DYNAMICALLY RESPONDING TO DETECTED CHANGES IN A SEMANTIC MAP OF AN AUTONOMOUS VEHICLE

(71) Applicant: GM CRUISE HOLDINGS LLC, San Francisco, CA (US)

(72) Inventors: Tucker Allen Paxton, San Mateo, CA (US); Lucio Otavio Marchioro Rech, San Mateo, CA (US); Eric Michael Lujan, San Francisco, CA (US)

(73) Assignee: GM CRUISE HOLDINGS LLC, San Francisco, CA (US)

(21) Appl. No.: 17/714,676

(22) Filed: Apr. 6, 2022

(51) Int. Cl. B60W 60/00; G07C 5/02

(52) U.S. Cl. CPC B60W 60/0015; G07C 5/02; B60W 60/0013; B60W 2556/40; B60W 2710/18; B60W 2556/45; B60W 2555/60; B60W 2552/05; B60W 2552/50

(57) ABSTRACT

For one embodiment of the present disclosure, systems and methods for dynamically responding to detected changes in a semantic map of an autonomous vehicle (AV) are described. A computer implemented method includes obtaining sensor signals from a sensor system of the AV to monitor driving operations, processing the sensor signals for sensor observations of the sensor system, determining whether a map change exists between the sensor observations and a prerecorded semantic map, determining whether the map change is located in a planned route of the AV when the map change exists, and generating a first scenario with a first priority level to to stop the AV at a safe location based on a location of the map change.

### TECHNICAL FIELD

Embodiments described herein generally relate to the fields of autonomous vehicles and driver assistance vehicles, and more particularly relate to systems and methods for dynamically responding to detected changes in a semantic map of an autonomous vehicle.

### BACKGROUND

Autonomous vehicles, also known as self-driving cars, driverless vehicles, and robotic vehicles, may be vehicles that use multiple sensors to sense the environment and move without human input. Automation technology in the autonomous vehicles may enable the vehicles to drive on roadways and to accurately and quickly perceive the vehicle's environment, including obstacles, signs, and traffic lights. Autonomous technology may utilize map data that can include geographical information and semantic objects (such as parking spots, lane boundaries, intersections, crosswalks, stop signs, traffic lights) for facilitating driving safety. The vehicles can be used to pick up passengers and drive the passengers to selected destinations. The vehicles can also be used to pick up packages and/or other goods and deliver the packages and/or goods to selected destinations.

### SUMMARY

For one embodiment of the present disclosure, systems and methods for dynamically responding to detected changes in a semantic map of an autonomous vehicle (AV) are described. A computer implemented method includes obtaining sensor signals from a sensor system of the AV to monitor driving operations, processing the sensor signals for sensor observations of the AV, determining whether a map change exists between the sensor observations and a prerecorded semantic map, determining whether the map change is located in a planned route of the AV when the map change exists, and generating a first scenario with a first priority level to stop the AV at a safe location or move the AV to a safe region based on a location of the map change.

Other features and advantages of embodiments of the present disclosure will be apparent from the accompanying drawings and from the detailed description that follows below.

### BRIEF DESCRIPTION OF THE DRAWINGS

FIG. 1 illustrates an autonomous vehicle and remote computing system architecture in accordance with one embodiment.

FIG. 2 illustrates an exemplary autonomous vehicle 200 in accordance with one embodiment.

FIG. 3 illustrates a computer-implemented method 300 for dynamically responding to a detected anomaly between sensor observations from sensed data and an offline semantic map of a vehicle in accordance with one embodiment.

FIG. 4 illustrates a block diagram of a system architecture for dynamically responding to a detected anomaly between sensor observations from sensed data and an offline prerecorded semantic map of an autonomous vehicle in accordance with one embodiment.

FIG. 5 illustrates a functional block diagram for a vehicle (e.g., autonomous vehicle (AV), driver assisted vehicle) in accordance with another embodiment.

FIG. 6 is a block diagram of a vehicle 1200 having driver assistance according to an embodiment of the disclosure.

### DETAILED DESCRIPTION OF EMBODIMENTS

Autonomous driving decisions are based on a high fidelity map that defines lane boundaries, traffic control devices and drivable regions. In situations where the high fidelity map is not a reflection of the real world (e.g., out of date map with respect to real world), fully autonomous behavior is not possible and guidance from human operators is necessary.

For a lane change detection, some approaches handle a conflict between lane change detection and the map based on modifying a driving path using the lane change detection. For some approaches, when a new stop sign is put up, or lane paint is modified, the AV continues to drive based on the semantic map. This can result in entering intersections with newly placed stop signs, or unexpectedly crossing over newly painted lane lines.

Systems and methods for dynamically responding to detected changes in a semantic map of a vehicle (e.g., autonomous vehicle) are described herein. Upon determining a detected change in a semantic map, a response occurs that will generate a set of scenarios, evaluate each of the scenarios in the set, and select a scenario based on the evaluation for safely responding to the map change.

In the following description, for purposes of explanation, numerous specific details are set forth in order to provide a thorough understanding of the present disclosure. It will be apparent, however, to one skilled in the art that the present disclosure can be practiced without these specific details. In other instances, well-known structures and devices are shown in block diagram form in order to avoid obscuring the present disclosure.

Reference in the specification to “one embodiment” or “an embodiment” means that a particular feature, structure or characteristic described in connection with the embodiment is included in at least one embodiment of the present disclosure. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily all referring to the same embodiment.

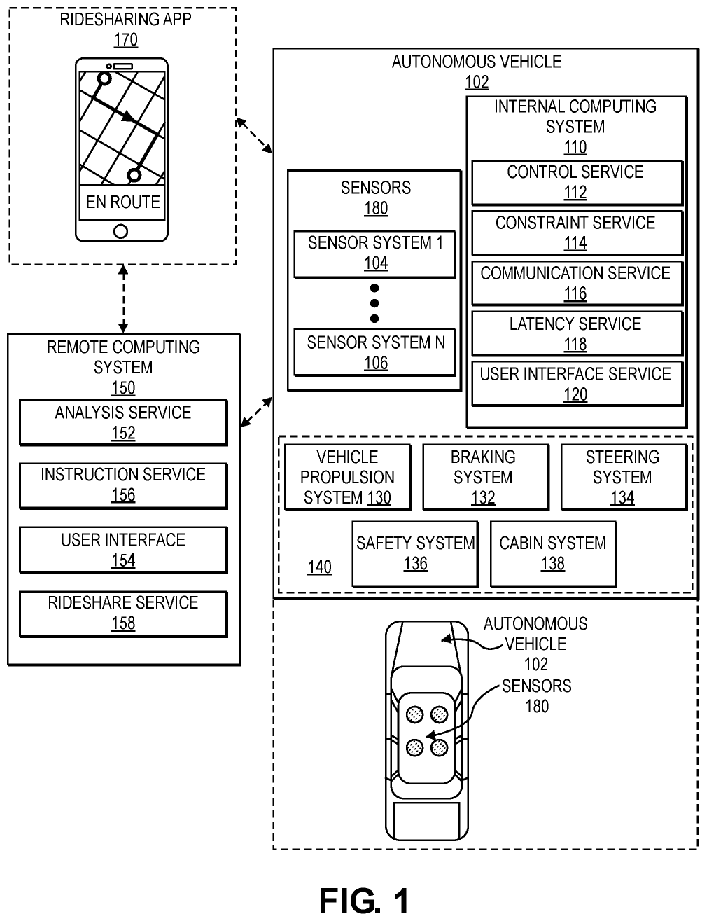

FIG. 1 illustrates an autonomous vehicle and remote computing system architecture in accordance with one embodiment. The autonomous vehicle 102 can navigate about roadways without a human driver based upon sensor signals output by sensor systems 180 of the autonomous vehicle 102. The autonomous vehicle 102 includes a plurality of sensor systems 180 (e.g., a first sensor system 104 through an Nth sensor system 106). The sensor systems 180 are of different types and are arranged about the autonomous vehicle 102. For example, the first sensor system 104 may be a camera sensor system and the Nth sensor system 106 may be a Light Detection and Ranging (LIDAR) sensor system to perform ranging measurements for localization.

The camera sensor system aids in classifying objects and tracking the objects over time. The camera sensor system also supports the identification of free space, among other things. The camera sensor system assists in differentiating various types of motor vehicles, pedestrians, bicycles, and free space. The camera sensor system can identify road objects such as construction cones, barriers, signs, and identify objects such as street signs, streetlights, trees and read dynamic speed limit signs. The camera sensor system can identify stops signs, traffic lights, modified lane boundaries, and modified curbs. The camera sensor system also identifies attributes of other people and objects on the road, such as brake signals from cars, reverse lamps, turn signals, hazard lights, and emergency vehicles, and detect traffic light states and weather.

The LIDAR sensor system supports localization of the vehicle using ground and height reflections in addition to other reflections. The LIDAR sensor system supports locating and identifying static and dynamic objects in space around the vehicle (e.g., bikes, other vehicles, pedestrians), ground debris and road conditions, and detecting headings of moving objects on the road.

Other exemplary sensor systems include radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems such as Global Positioning System (GPS) receiver systems, accelerometers, gyroscopes, inertial measurement units (IMU), infrared sensor systems, laser rangefinder systems, ultrasonic sensor systems, infrasonic sensor systems, microphones, or a combination thereof. While four sensors 180 are illustrated coupled to the autonomous vehicle 102, it should be understood that more or fewer sensors may be coupled to the autonomous vehicle 102.

The autonomous vehicle 102 further includes several mechanical systems that are used to effectuate appropriate motion of the autonomous vehicle 102. For instance, the mechanical systems can include but are not limited to, a vehicle propulsion system 130, a braking system 132, and a steering system 134. The vehicle propulsion system 130 may include an electric motor, an internal combustion engine, or both. The braking system 132 can include an engine brake, brake pads, actuators, and/or any other suitable componentry that is configured to assist in decelerating the autonomous vehicle 102. In some cases, the braking system 132 may charge a battery of the vehicle through regenerative braking. The steering system 134 includes suitable componentry that is configured to control the direction of movement of the autonomous vehicle 102 during navigation.

The autonomous vehicle 102 further includes a safety system 136 that can include various lights and signal indicators, parking brake, airbags, etc. The autonomous vehicle 102 further includes a cabin system 138 that can include cabin temperature control systems, in-cabin entertainment systems, etc.

The autonomous vehicle 102 additionally comprises an internal computing system 110 that is in communication with the sensor systems 180 and the systems 130, 132, 134, 136, and 138. The internal computing system includes at least one processor and at least one memory having computer-executable instructions that are executed by the processor. The computer-executable instructions can make up one or more services responsible for controlling the autonomous vehicle 102, communicating with remote computing system 150, receiving inputs from passengers or human co-pilots, logging metrics regarding data collected by sensor systems 180 and human co-pilots, etc.

The internal computing system 110 can include a control service 112 that is configured to control operation of a mechanical system 140, which includes vehicle propulsion system 130, the braking system 208, the steering system 134, the safety system 136, and the cabin system 138. The control service 112 receives sensor signals from the sensor systems 180 and communicates with other services of the internal computing system 110 to effectuate operation of the autonomous vehicle 102. In some embodiments, control service 112 may carry out operations in concert with one or more other systems of autonomous vehicle 102. The control service 112 can control driving operations of the autonomous vehicle 102 based on sensor signals from the sensor systems 180. In one example, the control service responds to detected map changes for a semantic map in order to safely stop the AV or move the AV to a safe region with no detected anomalies between sensor observations and the semantic map.

The internal computing system 110 can also include a constraint service 114 to facilitate safe propulsion of the autonomous vehicle 102. The constraint service 114 includes instructions for activating a constraint based on a rule-based restriction upon operation of the autonomous vehicle 102. For example, the constraint may be a restriction upon navigation that is activated in accordance with protocols configured to avoid occupying the same space as other objects, abide by traffic laws, circumvent avoidance areas, etc. In some embodiments, the constraint service can be part of the control service 112.

The internal computing system 110 can also include a communication service 116. The communication service can include both software and hardware elements for transmitting and receiving signals from/to the remote computing system 150. The communication service 116 is configured to transmit information wirelessly over a network, for example, through an antenna array that provides personal cellular (long-term evolution (LTE), 3G, 4G, 5G, etc.) communication.

In some embodiments, one or more services of the internal computing system 110 are configured to send and receive communications to remote computing system 150 for such reasons as reporting data for training and evaluating machine learning algorithms, requesting assistance from remoting computing system or a human operator via remote computing system 150, software service updates, ridesharing pickup and drop off instructions, etc.

The internal computing system 110 can also include a latency service 118. The latency service 118 can utilize timestamps on communications to and from the remote computing system 150 to determine if a communication has been received from the remote computing system 150 in time to be useful. For example, when a service of the internal computing system 110 requests feedback from remote computing system 150 on a time-sensitive process, the latency service 118 can determine if a response was timely received from remote computing system 150 as information can quickly become too stale to be actionable. When the latency service 118 determines that a response has not been received within a threshold, the latency service 118 can enable other systems of autonomous vehicle 102 or a passenger to make necessary decisions or to provide the needed feedback.

The internal computing system 110 can also include a user interface service 120 that can communicate with cabin system 138 in order to provide information or receive information to a human co-pilot or human passenger. In some embodiments, a human co-pilot or human passenger may be required to evaluate and override a constraint from constraint service 114, or the human co-pilot or human passenger may wish to provide an instruction to the autonomous vehicle 102 regarding destinations, requested routes, or other requested operations.

As described above, the remote computing system 150 is configured to send/receive a signal from the autonomous vehicle 102 regarding reporting data for training and evaluating machine learning algorithms, requesting assistance from remote computing system 150 or a human operator via the remote computing system 150, software service updates, rideshare pickup and drop off instructions, etc.

The remote computing system 150 includes an analysis service 152 that is configured to receive data from autonomous vehicle 102 and analyze the data to train or evaluate machine learning algorithms for operating the autonomous vehicle 102 such as performing methods disclosed herein. The analysis service 152 can also perform analysis pertaining to data associated with one or more errors or constraints reported by autonomous vehicle 102. In another example, the analysis service 152 is located within the internal computing system 110.

The remote computing system 150 can also include a user interface service 154 configured to present metrics, video, pictures, sounds reported from the autonomous vehicle 102 to an operator of remote computing system 150. User interface service 154 can further receive input instructions from an operator that can be sent to the autonomous vehicle 102.

The remote computing system 150 can also include an instruction service 156 for sending instructions regarding the operation of the autonomous vehicle 102. For example, in response to an output of the analysis service 152 or user interface service 154, instructions service 156 can prepare instructions to one or more services of the autonomous vehicle 102 or a co-pilot or passenger of the autonomous vehicle 102.

The remote computing system 150 can also include a rideshare service 158 configured to interact with ridesharing applications 170 operating on (potential) passenger computing devices. The rideshare service 158 can receive requests to be picked up or dropped off from passenger ridesharing app 170 and can dispatch autonomous vehicle 102 for the trip. The rideshare service 158 can also act as an intermediary between the ridesharing app 170 and the autonomous vehicle wherein a passenger might provide instructions to the autonomous vehicle to 102 go around an obstacle, change routes, honk the horn, etc.

The rideshare service 158 as depicted in FIG. 1 illustrates a vehicle 102 as a triangle en route from a start point of a trip to an end point of a trip, both of which are illustrated as circular endpoints of a thick line representing a route traveled by the vehicle. The route may be the path of the vehicle from picking up the passenger to dropping off the passenger (or another passenger in the vehicle), or it may be the path of the vehicle from its current location to picking up another passenger.

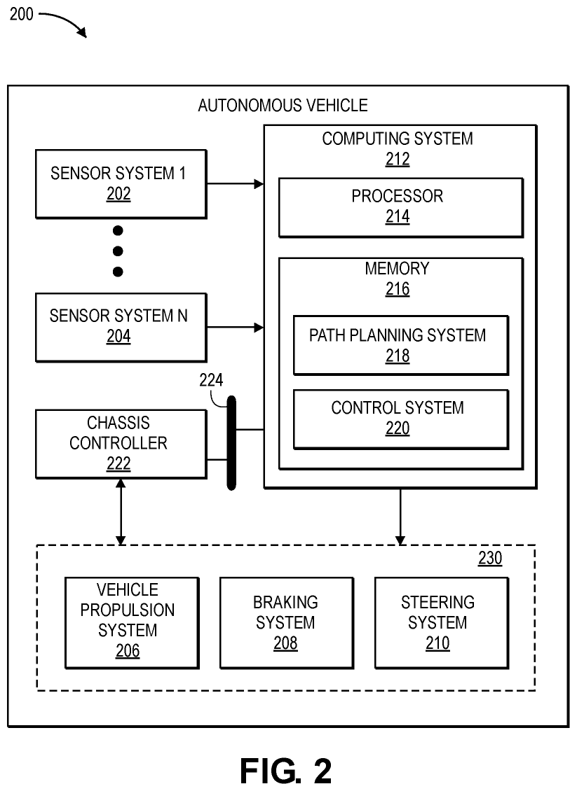

FIG. 2 illustrates an exemplary autonomous vehicle 200 in accordance with one embodiment. The autonomous vehicle 200 can navigate about roadways without a human driver based upon sensor signals output by sensor systems 202-204 of the autonomous vehicle 200. The autonomous vehicle 200 includes a plurality of sensor systems 202-204 (a first sensor system 202 through an Nth sensor system 204). The sensor systems 202-204 are of different types and are arranged about the autonomous vehicle 200. For example, the first sensor system 202 may be a camera sensor system and the Nth sensor system 204 may be a lidar sensor system. Other exemplary sensor systems include, but are not limited to, radar sensor systems, global positioning system (GPS) sensor systems, inertial measurement units (IMU), infrared sensor systems, laser sensor systems, sonar sensor systems, and the like. Furthermore, some or all of the of sensor systems 202-204 may be articulating sensors that can be oriented/rotated such that a field of view of the articulating sensors is directed towards different regions surrounding the autonomous vehicle 200.

A detector of the sensor system provides perception by receiving raw sensor input and using it to determine what is happening around the vehicle. Perception deals with a variety of sensors, including LiDAR, radars, and cameras. The perception functionality provides raw sensor detection and sensor fusion for tracking and prediction of different objects around the vehicle.

The autonomous vehicle 200 further includes several mechanical systems that can be used to effectuate appropriate motion of the autonomous vehicle 200. For instance, the mechanical systems 230 can include but are not limited to, a vehicle propulsion system 206, a braking system 208, and a steering system 210. The vehicle propulsion system 206 may include an electric motor, an internal combustion engine, or both. The braking system 208 can include an engine break, brake pads, actuators, and/or any other suitable componentry that is configured to assist in decelerating the autonomous vehicle 200. The steering system 210 includes suitable componentry that is configured to control the direction of movement of the autonomous vehicle 200 during propulsion.

The autonomous vehicle 200 additionally includes a chassis controller 222 that is activated to manipulate the mechanical systems 206-210 when an activation threshold of the chassis controller 222 is reached.

The autonomous vehicle 200 further comprises a computing system 212 that is in communication with the sensor systems 202-204, the mechanical systems 206-210, and the chassis controller 222. While the chassis controller 222 is activated independently from operations of the computing system 212, the chassis controller 222 may be configured to communicate with the computing system 212, for example, via a controller area network (CAN) bus 224. The computing system 212 includes a processor 214 and memory 216 that stores instructions which are executed by the processor 214 to cause the processor 214 to perform acts in accordance with the instructions.

The memory 216 comprises a path planning system 218 and a control system 220. The path planning system 218 generates a path plan for the autonomous vehicle 200. The path plan can be identified both spatially and temporally according to one or more impending timesteps. The path plan can include one or more maneuvers to be performed by the autonomous vehicle 200. The path planning system 218 may implement operations for planning components 420 and 430, or planning/execution layer 540 in order to generate, evaluate, and a select a scenario in response to a detected change in a semantic map.

The control system 220 is configured to control the mechanical systems of the autonomous vehicle 200 (e.g., the vehicle propulsion system 206, the brake system 208, and the steering system 210) based upon an output from the sensor systems 202-204 and/or the path planning system 218. For instance, the mechanical systems can be controlled by the control system 220 to execute the path plan determined by the path planning system 218. Additionally, or alternatively, the control system 220 may control the mechanical systems 206-210 to navigate the autonomous vehicle 200 in accordance with outputs received from the sensor systems 202-204. The control system 220 can control driving operations of the autonomous vehicle 200 based on receiving vehicle commands from the planning system 218.

To fully deploy a driverless service, a mechanism to bring the AV to a stop in a safe manner in accordance with legal constraints and to allow advisors to path the car outside of areas where a ground truth from sensed data and the semantic map diverged is necessary.

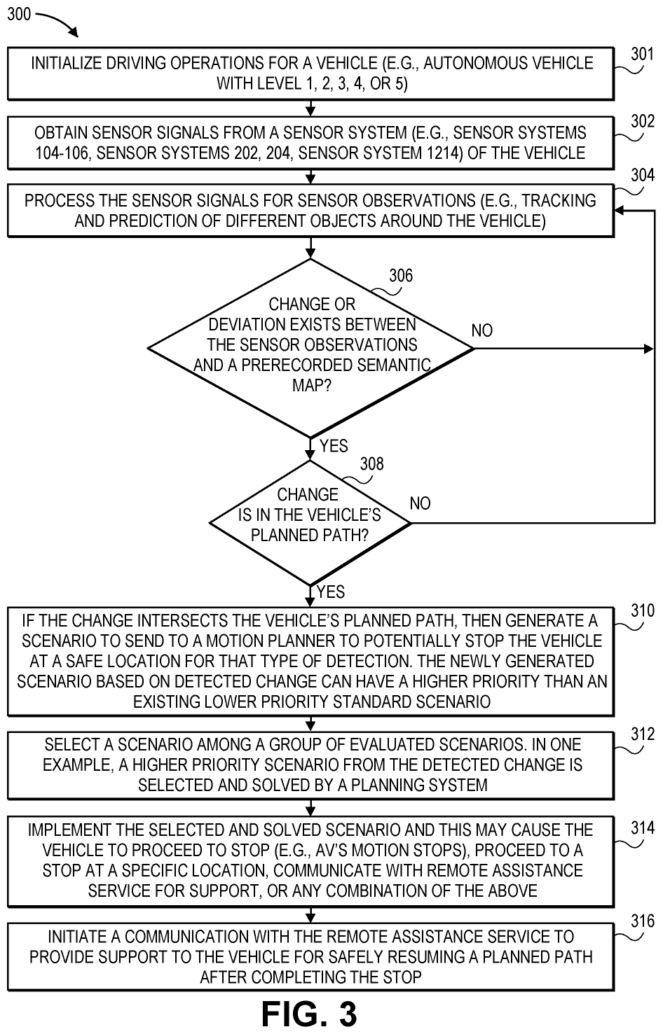

FIG. 3 illustrates a computer-implemented method 300 for dynamically responding to a detected anomaly between sensor observations from sensed data and an offline semantic map of a vehicle in accordance with one embodiment. In one example, sensor signals with sensor data can be obtained from different types of sensors that are coupled to a device, which may be a vehicle, such as vehicle 102, vehicle 200, or vehicle 1200. This computer-implemented method 300 can be performed by processing logic of a computing system that may comprise hardware (circuitry, dedicated logic, a processor, etc.), software (such as is run on a general purpose computer system or a dedicated machine or a device or planning software), or a combination of both. The method 300 can be performed by an internal computing system 110 or remoting computing system 150 of FIG. 1, the computing system 212 of FIG. 2, or the system 1202.

At operation 301, the computer-implemented method 300 initializes driving operations for a vehicle (e.g., autonomous vehicle with full driving automation (level 5) and no human attention needed, high driving automation (level 4) with no human attention needed in most circumstances, conditional driving automation (level 3) with a human ready to override the AV, partial automation mode (level 2) with the vehicle having automated functions such as acceleration and steering but the driver remains engaged with the driver task and monitors an environment, and driver assistance mode (level 1) with the vehicle controlled by the driver but some driver assist features).

At operation 302, the computer-implemented method 300 obtains sensor signals from a sensor system (e.g., sensor systems 104-106, sensor systems 202, 204, sensor system 1214) of the vehicle. The sensor signals can be obtained from a camera sensor system and a Light Detection and Ranging (LIDAR) sensor system to perform ranging measurements for localization of the vehicle, chassis of the vehicle, and nearby objects within a certain distance of the vehicle and the sensor system. Other exemplary sensor systems include radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems such as Global Positioning System (GPS) receiver systems, accelerometers, gyroscopes, inertial measurement units (IMU), infrared sensor systems, laser rangefinder systems, ultrasonic sensor systems, infrasonic sensor systems, microphones, or a combination thereof. Localization of the vehicle may include determining location of the tires and chassis.

At operation 304, the computer-implemented method 300 processes the sensor signals to determine sensor observations. In one example, one or more processors (e.g., processor 1268) processes the sensor signals for tracking and prediction of different objects around the vehicle. At operation 306, the computer-implemented method determines whether a change or deviation (e.g., addition of stop signs, an addition of traffic lights, modified lane boundaries, and modified curbs) exists between the sensor observations for tracking and prediction of different objects around the vehicle and a prerecorded semantic map. In one example, a deviation from the semantic map can occur when significant changes to a city or region occur after a most recent map labelling update. For example, if a city repaints lane lines after a most recent map labelling update, then the location of these lane lines will not be captured in the semantic map until a next semantic map release occurs. In one embodiment, the prerecorded semantic map includes road segments, interconnections, a number of lanes, direction of travel for the lanes, and yield relationships between roads and lanes to allow the vehicle to safely operate. The prerecorded semantic map may also include traffic light location, traffic light status, traffic intersection data, stop signs, lane boundaries, and curbs. The prerecorded semantic map can be updated periodically.

The change or deviation can be compared to a change response threshold. The change if reaching or meeting the change response threshold can cause a switch from a negative map response signal to a positive map response signal.

At operation 308, the computer-implemented method 300 determines whether a location of the change (e.g., location for addition of stop sign, location for an addition of traffic lights, location for modified lane boundaries, and location for modified curbs) is in the AV's planned path for the change response threshold. In one example, for a new stop sign or traffic light detection to reach or meet a change response threshold, the affected intersection for the new stop sign or traffic light must fall within the AVs planned route. For a new or modified lane paint detection to reach or meet a change response threshold, the location of the new or modified lane paint must intersect the AVs planned route. For a new or modified curb to reach or meet a change response threshold, the new curb location must lie near or along the AVs planned path. If the curb falls very close to the planned path, the autonomous driving system will plan a smooth lateral deviation to provide some buffer spacing to the curb (e.g., the AV will nudge a short distance to the left or right to ensure a certain safe distance exists between the AV and the newly detected curb, which is considered to be an obstacle).

If the change intersects the AV's planned path to reach or meet the change response threshold, then at operation 310 the computer-implemented method generates a scenario to send to a motion planner to potentially stop the vehicle at a safe location. The newly generated scenario from the detected change may be urgent and can have a higher priority than an existing lower priority standard scenario.

If a location of the change or deviation is not within the AV's planned route and thus fails to reach or meet the change response threshold, then the method returns to operation 304.

For different types of change detections, different parameters for the generated scenario are possible such as how aggressively to apply braking, what type of locations to stop in (e.g., not permitted to stop in an intersection, allowed to stop in safe locations, allowed to stop adjacent to a curb, etc.) and urgency/discomfort parameters are set as required by desired behavior such as a stopping policy. The discomfort parameters may have different levels of discomfort (e.g., low, medium, high) for the desired behavior. The scenario will have the parameters for aggressive braking, low-aggression braking, etc.

At operation 312, the computer-implemented method 300 selects a scenario among a group of evaluated scenarios. In one example, a higher priority scenario from the detected change is selected and solved by a planning system. At operation 314, the computer-implemented method 300 implements the selected and solved scenario and this may cause the AV to proceed to stop (e.g., AV's motion stops), proceed to a stop at a specific safe location, communicate with remote assistance for support, or any combination of the above.

At operation 316, the computer-implemented method 300 initiates a communication with a remote assistance service to provide support to the AV for safely resuming a planned path upon completing the stop. The remote assistance service instructs the AV when the AV can safely resume driving from the stopped position and return to the planned path. It is expected that the AV will respond to the listed map changes and at the same time initiate a remote assistance session and coming to a safe and (when possible) comfortable stop. The remote assistance service enables control of the AV by a remote human advisor. The remote human advisor can assist for more complex driving situations (e.g., fog, a parade, etc.) while the AV's sensors and control execute the manuevers. The remote assistance service can use a perception override to instruct the AV about objects or portions of a road to ignore.

This present disclosure describes systems and a method for providing a dynamic response to a detected change between sensed observations and a prerecorded semantic map. The detected change can include an addition of stop signs (e.g., intersection lane changes from uncontrolled to stop sign controlled, or from traffic light controlled to stop sign controlled), an addition of traffic lights (e.g., intersection lane changes from uncontrolled to traffic light controlled, or from stop sign controlled to traffic light controlled), modified lane boundaries, and modified curbs (e.g., modified curbs extending into a region that was previously a drivable area). In each of these cases, when a map change is detected, it may be desirable for the AV to engage hazard lights to warn traffic of intent to stop, connect to remote assistance to navigate the affected area, and stop, using the full capabilities of the planning system, as soon as it is determined that is safe to do so, considering the interaction with other road users and in a comfortable but urgent way. This stopping method may not dictate a specific stopping location, but it can specify regions to avoid stopping in. This allows the planning system to reason about a variety of constraints (e.g., stopping soon, avoid being rear ended, comfort, etc.) just as it does during nominal driving.

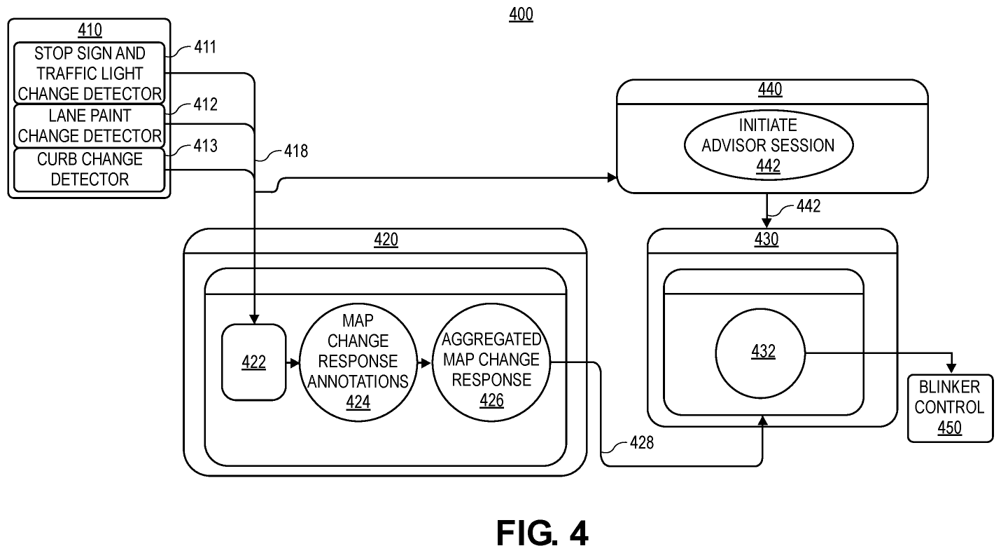

FIG. 4 illustrates a block diagram of a system architecture for dynamically responding to a detected anomaly between sensor observations from sensed data and an offline prerecorded semantic map of an autonomous vehicle in accordance with one embodiment. The system 400 includes a detector 410, a planning component 420, a planning component 430, and remote assistance 440. Planning components 420 and 430 are components of a planning system (e.g., path planning system 218, planning/execution layer 540). Output from the planning components can be used by a control system (e.g., control service 112, control system 220) to control the mechanical systems of an autonomous vehicle (e.g., the vehicle propulsion system 206, the brake system 208, and the steering system 210). In one example, sensor signals with sensor data can be obtained from different types of sensors that are coupled to a device, which may be a vehicle, such as vehicle 102, vehicle 200, or vehicle 1200. The operations of the detector 410, a planning component 420, and a planning component 430 can be performed by processing logic of a computing system that may comprise hardware (circuitry, dedicated logic, a processor, etc.), software (such as is run on a general purpose computer system or a dedicated machine), or a combination of both. The operations can be performed by an internal computing system 110 or remoting computing system 150 of FIG. 1, the computing system 212 of FIG. 2, or the system 1202.

The detector 410 includes detector component 411 to detect a change in a stop sign or traffic light (e.g., intersection lane changes from uncontrolled (no stop sign) to stop sign controlled, or from traffic light controlled to stop sign controlled, intersection lane changes from uncontrolled to traffic light controlled, or from stop sign controlled to traffic light controlled), a detector component 412 to detect a change in modified lane boundaries, and a detector component 413 to detect a change in modified curbs (e.g., modified curbs extending into a region that was previously a drivable area). In one example, the change is a detected anomaly between sensor observations from sensed data of the autonomous vehicle and an offline prerecorded semantic map that is stored within the autonomous vehicle and periodically updated.

The detector component 412 communicates its output including a location to identify which planned paths or routes are affected by a change detection to planning component 420. The detector component 413 communicates its output including a polygon to identify which planned paths or routes are affected by a change detection to planning component 420. The polygon represents a drivable area intersected by a curb geometry. In one example, all changes are communicated or transmitted continuously to identify if a change detection signal has changed to negative or false.

A map change is stateless and can occur immediately on receiving a positive map change detection and will stop occurring when that map change detection signal from the detector 410 becomes negative. If the AV is stopping for a change detection and the detector 410 stops reporting this change, then the AV will resume nominal driving.

The detector 410 determines when changes or deviations between sensed observations and an offline sematic map occur. The detector 410 sends map change signals 418 to the planning component 420 and the remote assistance 440. The planning component 420 includes a component 422 to provide different possible scenarios for the AV. The component 424 generates one or more scenarios with each scenario having a directive. The scenarios can have different priority levels with a map change signal causing a generated scenario to have a higher priority level. A set of static functions can be called to populate a new annotation field in each scenario. An annotation field can include a declarative stop request array, a suggested stop point, and commit region to request the AV not stop in a specified region. The planning component 420 provides the following key aspects of a scenario:

(1) Reference: centerline and boundary information for structuring the problem.

(2) Trajectory Policy: provides details on how the planning component 430 internally costs trajectories, controlling how aggressively the planning component 430 will attempt to fulfill a scenario. A trajectory policy can include a maximum discomfort having different levels of discomfort (e.g., low, medium, high).

(3) Goal: constraints on the end state of the scenario. Specifying this component allows a mission manager (e.g., mission manager 534) to specify detailed stopping scenarios.

(4) Scene Directives: offline semantic existing map and scene primitives that includes traffic lights and other traffic control devices and details like road speed and school zones. Scene directives are inputs to the planning component 430 (or trajectory planning system) that describe aspects about the local scene that need to be taken into account when generating trajectories. Examples of scene context include keep clear zones, traffic light states, yield graphs, speed bumps, hill crests, etc. The planning component 430 will consider and attempt to satisfy all costs derived from scene context.

(5) A Mission whether it comes from dispatch or from AV override mission source such as a map change signal, is translated into one or more planner scenarios which encode the intent of the Mission within an interface suitable for the planner to generate and evaluate candidate solutions.

For component 426, the scenarios are aggregated into an aggregated map change 428 that is sent to the planning component 430. The component 432 selects a scenario (e.g., highest or higher priority level that is feasible and satisfies goal conditions) among a list of scenarios to be solved in the AV. A goal is formulated to bring the AV to a stop subject to scene context, legal constraints, and safety parameters. When a scenario manager provides a set of scenarios that includes an unchosen scenario with a higher priority than the currently active scenario, the planning component 430 will attempt to solve and transition to this more preferred scenario. If the scenario causes stopping the AV, blinker control 450 is activated to engage hazard lights on request.

Upon receiving a positive map change signal that indicates that an offline semantic map and ground truth from sensor observations have deviated, the system architecture initiates an autonomous response to bring the AV to a stop. No maturation time for these map change signals exist (i.e., upon a detection the response is immediate). Maturation and stability of the signal is assumed to happen at detection.

Stopping behavior is dependent on which detector 411, 412, and 413 was triggered. A request to initiate a Remote Assistance (RA) session 442 of remote assistance 440 is transmitted as soon as any detector is triggered. The remote assistance will navigate the AV past a change detection after the AV is stopped. When a map change detection occurs, Remote Assistance will automatically initiate an RA session. RA will use an existing suite of tools to path the AV forward when appropriate, handing back control to the AV when detectors are false and all other existing constraints are met. Blinker hazard lights will engage for the duration of the map change signal. Once Remote Assistance connects, standard blinker logic will apply for an advisor assisted session, regardless of map change detection signal.

When stopping at an intersection (e.g., for stop sign and traffic light changes), the planning component 430 prefers to stop the AV just before the intersection. A late detection may make this infeasible (i.e., kinematically infeasible, imminent rear collision). Infeasible indicates a scenario that cannot be satisfied to meet goal conditions. The stop policy will allow motion plans which stop within the crosswalk, as this is still safer than driving through an intersection which deviates from ground truth. Driving all the way through the intersection will be preferred to stopping in the intersection. In this case, the affected intersection will no longer be in the AV's lane plan, and the map change will stop being requested.

When stopping midblock (e.g., for Lane Paint and Curb changes), the planning component 430 will prefer to stop as soon as safely and comfortably possible. There is no benefit to driving to the edge of the affected curb or lane paint. If the AV is imminently approaching an intersection, planning component 430 will still prefer to stop as soon as possible, and will prefer stopping before the intersection, or in the intersection crosswalk.

The planning component 430 may include mathematical software (e.g., computer program, software library) to provide a coarse lateral plan, a path plan, and longitudinal planning. Lateral and longitudinal motions planners may also be integrated with the planning component 430. The planning is based on input scenarios, predictions and tracking of different objects, and free space inclusion information. The planning component 430 uses optimization techniques and a generates a set of reference trajectories for the vehicle.

The system architecture provides automated real-time detection of and response to stop signs and traffic lights, lane paint changes, and modified curbs within a drivable area. The real time detection and response mitigates safety risks of side impact collision due to running a new placed stop sign or traffic lights. A high safety risk exists for vulnerable road user collisions. Real-time detection and response mitigate risk of the AV violating pedestrian right-of-way at crosswalks.

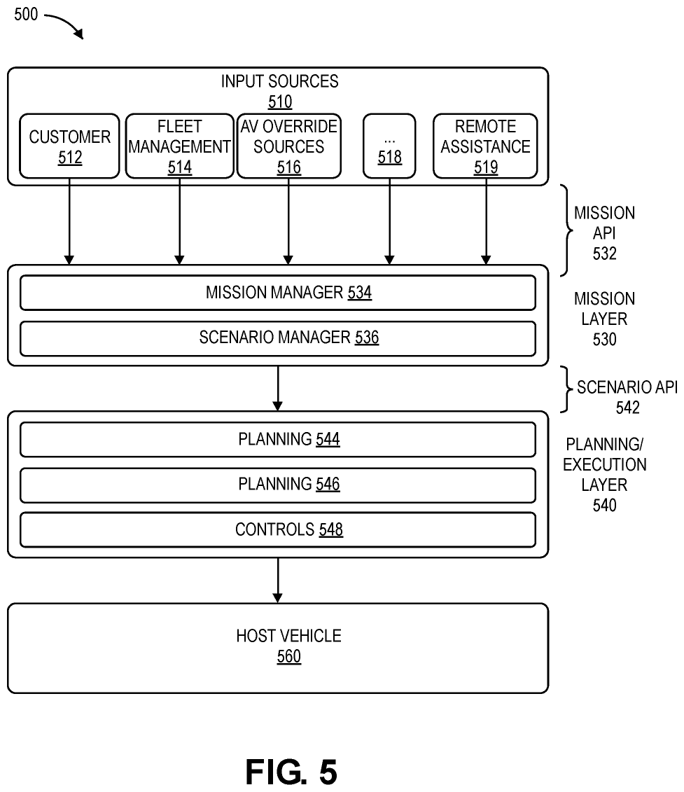

FIG. 5 illustrates a functional block diagram for operations of a vehicle (e.g., autonomous vehicle (AV), driver assisted vehicle) in accordance with another embodiment. The diagram 500 includes input sources 510, a mission layer 530, a planning/execution layer 540 and a host vehicle 560. The input sources 510 can include customer 512 to send an input address to the mission layer 530, a fleet management source 514 to send an instruction (e.g., return to base station and charge the AV) to the mission layer, AV override sources 516 (e.g., map change detector 410 to detect map changes, emergency vehicle detected, end trip request, collision detector), other sources 518, and remote assistance 519 to send a request to the mission layer 530.

The mission API 532 provides a single API between input sources and the mission layer 530. At the mission level, the requests will be high level and express the intent, without explicit knowledge of the specific implementation detail. Every input source will request one or more missions using the same, unified API. Missions express the intent at the semantic level (i.e., “Drive to A”). The amount of information contained in a request can be minimal or even incomplete; the responsibility of the mission layer is to collect the requests from the different input sources and deconflict them using the current state and context.

Context and additional constraints can be sent independently from the intent with the main rationale being that some input source may not have enough context to communicate the best possible intent. In one example, a map change detector does not need to be aware of which mission is active. The mission layer has a more complete understanding of the context, and can decide the best action (e.g., reduce speed if the map change is non-critical, or switch to a “Stop” mission in case the change is critical).

At any point in time more than one mission request can be sent from the different input sources, and it is the mission layer's 530 responsibility to select the mission to execute.

At the scenario manager 536, the missions will be translated into a more geometric and quantitative description of the sequence of actions that are requested to the planning/execution layer 540. These requests will be passed to the planning/execution layer 540 using a common and unified scenario API 542, that every planner will implement and execute according to their specific capabilities.

Scenarios are tactical and mapped to the underlying vehicle capabilities, and the scenario API will reflect that. A scenario contains constraints on the end state of the scenario, reference waypoints, and additional information like urgency, etc. Specifying this component allows the mission manager 534 to specify detailed stopping scenarios. The scenario manager 536 handles normal driving, consolidating the high-level decisions communicated by the mission manager 534 and the current driving and environment context into a continuously updated scenario that is then communicated to the planning layer 540 using the scenario API 542. The scenario manager 536 uses a routing engine to lead the vehicle towards a global goal by defining intermediate goals that correspond to goals in the local horizon that make progress towards the final destination.

The scenario manager 536 packages these goals in the local horizon with global route costs to give the downstream planner enough context to make decisions around impatience and trade-offs with global trip cost. The scenario manager 536 processes goal and scenario override interrupts (e.g., map change detection, immediate pullover button, cabin tampering, remote assistance). When a global goal is nearby, the scenario manager 536 directly sends this goal to the downstream planner layer 540. Scenarios are created in the mission layer 530, and sent to the planning/execution layer 540 as an ordered list of scenarios.

The planning/execution layer 540 includes a planning preprocessor 544, a planning solver 546, and controls 548. The planning preprocessor 544 handles details of driving that are not handled by the planning solver 546 and any intermediate scene preprocessing as needed. Examples include exact pullover location selection, EMV response, etc. Some or most of the logic in the planning preprocessor 544 can be transferred to the solver 546. The planning/execution layer 540 will accept a proposed and prioritized set of scenarios or goals from the scenario manager 536, solve the scenarios or goals leveraging the priority, execute the best candidate scenario, report information about the solutions to the mission layer 530, and produce trajectory plans for the controls 548, which will generate and send vehicle command signals to the host vehicle 560 based on the trajectory plans.

There could be more than one planner (e.g., nominal and fallback stacks), and each planner can internally use several different algorithms and solvers, but the planners will all use a common scenario API 542. After the planning layer finishes solving, the planning layer shares whether each scenario was satisfied and the mission manager uses this information to track progress towards scenario completion and manage a current portfolio of active scenarios.

The result of the requests is communicated back to the mission layer 530, which can then propagate it back to the customer (Remote Operator for example) or reuse it to re-prioritize subsequent scenarios. The planning layer will not need to wait for the mission manager to select the best scenario to be executed, and only needs to report the relevant information at every clock tick. That information contains, among others, which scenarios have been explored, success/failure flags, the active scenario and its progress.

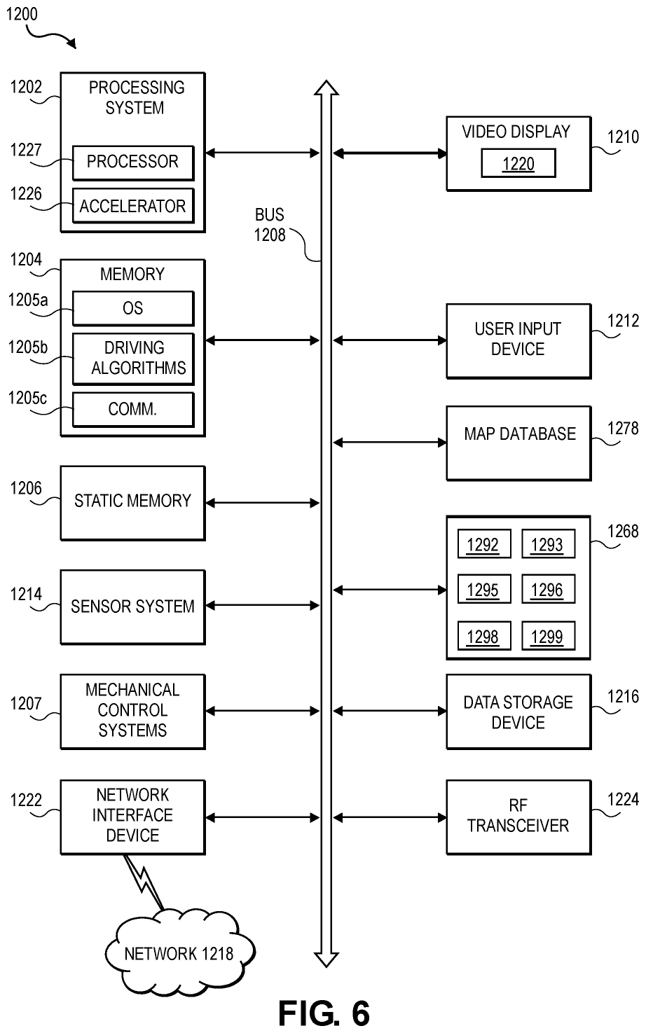

FIG. 6 is a block diagram of a vehicle 1200 having driver assistance according to an embodiment of the disclosure. Within the processing system 1202 (or computer system 1202) is a set of instructions (one or more software programs) for causing the machine to perform any one or more of the methodologies discussed herein including method 300. In alternative embodiments, the machine may be connected (e.g., networked) to other machines in a LAN, an intranet, an extranet, or the Internet. The machine can operate in the capacity of a server or a client in a client-server network environment, or as a peer machine in a peer-to-peer (or distributed) network environment, the machine can also operate in the capacity of a web appliance, a server, a network router, switch or bridge, event producer, distributed node, centralized system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The processing system 1202, as disclosed above, includes processing logic in the form of a general purpose instruction-based processor 1227 or an accelerator 1226 (e.g., graphics processing units (GPUs), FPGA, ASIC, etc.)). The general purpose instruction-based processor may be one or more general purpose instruction-based processors or processing devices (e.g., microprocessor, central processing unit, or the like). More particularly, processing system 1202 may be a complex instruction set computing (CISC) microprocessor, reduced instruction set computing (RISC) microprocessor, very long instruction word (VLIW) microprocessor, general purpose instruction-based processor implementing other instruction sets, or general purpose instruction-based processors implementing a combination of instruction sets. The accelerator may be one or more special-purpose processing devices such as an application specific integrated circuit (ASIC), a field programmable gate array (FPGA), a digital signal general purpose instruction-based processor (DSP), network general purpose instruction-based processor, many light-weight cores (MLWC) or the like. Processing system 1202 is configured to perform the operations and methods discussed herein. The exemplary vehicle 1200 includes a processing system 1202, main memory 1204 (e.g., read-only memory (ROM), flash memory, dynamic random access memory (DRAM) such as synchronous DRAM (SDRAM) or DRAM (RDRAM), etc.), a static memory 1206 (e.g., flash memory, static random access memory (SRAM), etc.), and a data storage device 1216 (e.g., a secondary memory unit in the form of a drive unit, which may include fixed or removable non-transitory computer-readable storage medium), which communicate with each other via a bus 1208. The storage units disclosed herein may be configured to implement the data storing mechanisms for performing the operations and methods discussed herein. Memory 1206 can store code and/or data for use by processor 1227 or accelerator 1226. Memory 1206 include a memory hierarchy that can be implemented using any combination of RAM (e.g., SRAM, DRAM, DDRAM), ROM, FLASH, magnetic and/or optical storage devices. Memory may also include a transmission medium for carrying information-bearing signals indicative of computer instructions or data (with or without a carrier wave upon which the signals are modulated).

Processor 1227 and accelerator 1226 execute various software components stored in memory 1204 to perform various functions for system 1202. Furthermore, memory 1206 may store additional modules and data structures not described above.

The vehicle 1200 includes a map database 1278 that downloads and stores map information for different, and various locations, where the map database 1278 is in communication with the bus 1208.

The processor 1268 would include a number of algorithms and sub-systems for providing perception and coordination features including perception input 1296, central sensor fusion 1298, external object state 1295, host state 1292, situation awareness 1293 and localization and maps 1299.

Operating system 1205a includes various procedures, sets of instructions, software components and/or drivers for controlling and managing general system tasks and facilitates communication between various hardware and software components. Driving algorithms 1205b (e.g., object detection, segmentation, path planning, method 300, etc.) utilize sensor data from the sensor system 1214 to provide object detection, segmentation, map change signals, and driver assistance features for different applications such as driving operations of vehicles. A communication module 1205c provides communication with other devices utilizing the network interface device 1222 or RF transceiver 1224.

The vehicle 1200 may further include a network interface device 1222. In an alternative embodiment, the data processing system disclosed is integrated into the network interface device 1222 as disclosed herein. The vehicle 1200 also may include a video display unit 1210 (e.g., a liquid crystal display (LCD), LED, or a cathode ray tube (CRT)) connected to the computer system through a graphics port and graphics chipset, an input device 1212 (e.g., a keyboard, a mouse), and a Graphic User Interface (GUI) 1220 (e.g., a touch-screen with input & output functionality) that is provided by the video display unit 1210.

The vehicle 1200 may further include a RF transceiver 1224 that provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/de-interleaving, spreading/dispreading, inverse fast Fourier transforming (IFFT)/fast Fourier transforming (FFT), cyclic prefix appending/removal, and other signal processing functions.

The data storage device 1216 may include a machine-readable storage medium (or more specifically a non-transitory computer-readable storage medium) on which is stored one or more sets of instructions embodying any one or more of the methodologies or functions described herein. Disclosed data storing mechanism may be implemented, completely or at least partially, within the main memory 1204 and/or within the data processing system 1202, the main memory 1204 and the data processing system 1202 also constituting machine-readable storage media.

In one example, the vehicle 1200 with driver assistance is an autonomous vehicle that may be connected (e.g., networked) to other machines or other autonomous vehicles using a network 1218 (e.g., LAN, WAN, cellular network, or any network). The vehicle can be a distributed system that includes many computers networked within the vehicle. The vehicle can transmit communications (e.g., across the Internet, any wireless communication) to indicate current conditions (e.g., an alarm collision condition indicates close proximity to another vehicle or object, a collision condition indicates that a collision has occurred with another vehicle or object, etc.). The vehicle can operate in the capacity of a server or a client in a client-server network environment, or as a peer machine in a peer-to-peer (or distributed) network environment. The storage units disclosed in vehicle 1200 may be configured to implement data storing mechanisms for performing the operations of autonomous vehicles.

The vehicle 1200 also includes sensor system 1214 and mechanical control systems 1207 (e.g., chassis control, vehicle propulsion system, driving wheel control, brake control, etc.). The system 1202 executes software instructions to perform different features and functionality (e.g., driving decisions, response to map change signals) and provide a graphical user interface 1220 for an occupant of the vehicle. The system 1202 performs the different features and functionality for autonomous operation of the vehicle based at least partially on receiving input from the sensor system 1214 that includes lidar sensors, cameras, radar, GPS, and additional sensors. The system 1202 may be an electronic control unit for the vehicle.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

1. A computer implemented method for operation of an autonomous vehicle (AV) comprising:
obtaining sensor signals from a sensor system of the AV to monitor driving operations;
processing the sensor signals for sensor observations of the sensor system;
determining whether a map change for a prerecorded semantic map is detected based on the sensor observations;
determining whether the map change is located in a planned route of the AV when the map change exists; and
generating a first scenario with a first priority level to stop the AV at a safe location based on a location of the map change.

2. The computer implemented method of claim 1, further comprising:
evaluating the first scenario with the first priority level and other scenarios including a second scenario with a second priority level.

3. The computer implemented method of claim 1, wherein for different types of map changes, different parameters for the first scenario include how aggressively to apply braking, what type of locations to stop in, and urgency and discomfort parameters for a stopping policy.

4. The computer implemented method of claim 1, further comprising:
selecting and solving the first scenario due to the first priority level being a higher priority than other priority levels and the first scenario being feasible.

5. The computer implemented method of claim 1, further comprising:
initiating a communication to remote assistance to provide support to the AV for safely resuming a planned path upon completing the stop at the safe location.

6. The computer implemented method of claim 1, wherein the map change includes a change of a stop sign when an intersection lane changes from uncontrolled to stop sign controlled, or from traffic light controlled to stop sign controlled, or a change of a traffic light when an intersection lane changes from uncontrolled to traffic light controlled, or from stop sign controlled to traffic light controlled.

7. The computer implemented method of claim 1, wherein the map change includes a modified lane boundary or a modified curb.

8. A computing system, comprising:
a memory storing instructions; and
a processor coupled to the memory, the processor is configured to execute instructions of a software program to:
determine when changes or deviations between sensed observations of an autonomous vehicle (AV) and an offline sematic map occur, generate map change signals based on the changes or deviations, and generate one or more scenarios with each scenario having a directive and a priority level with a map change signal causing a generated scenario to have a higher priority level than other scenarios.

9. The computing system of claim 8, wherein each scenario includes a reference to indicate a centerline and boundary information for the AV and a trajectory policy to indicate costs for potential trajectories controlling how aggressively to attempt to fulfill a scenario.

10. The computing system of claim 8, wherein each scenario includes a goal to indicate constraints on an end state of the scenario to specify details for safely stopping the AV subject to scene context, legal constraints, and safety parameters.

11. The computing system of claim 8, wherein each scenario includes scene directives to provide scene context for the AV.

12. The computing system of claim 8, wherein the processor is configured to execute instructions of the software program to:
evaluate the one or more scenarios and select a scenario based on priority level, feasibility, and ability to satisfy goal conditions among the one or more scenarios.

13. The computing system of claim 12, wherein the processor is configured to execute instructions of the software program to:
activate blinker control to engage hazard lights on request when the selected scenario is causing the AV to safely stop.

14. A non-transitory computer readable storage medium having embodied thereon a program, wherein the program is executable by a processor to perform a method comprising:
obtaining sensor signals from a sensor system of an autonomous vehicle (AV) to monitor driving operations;
processing the sensor signals for sensor observations of the sensor system;
determining whether a map change exists between the sensor observations and a prerecorded semantic map;
determining whether the map change is located in a planned route of the AV when the map change exists; and
generating a first scenario with a first priority level to stop the AV at a safe location based on a location of the map change.

15. The non-transitory computer readable storage medium of claim 14, wherein the method further comprises:
evaluating the first scenario with the first priority level and other scenarios including a second scenario with a second priority level.

16. The non-transitory computer readable storage medium of claim 14, wherein for different types of map changes, different parameters for the first scenario include how aggressively to braking, what type of locations to stop in, and urgency and discomfort parameters for a stopping policy.

17. The non-transitory computer readable storage medium of claim 14, wherein the method further comprises:
selecting and solving the first scenario due to the first priority level being a higher priority than other priority levels and the first scenario being feasible.

18. The non-transitory computer readable storage medium of claim 14, wherein the method further comprises:
initiating a communication to remote assistance to provide support to the AV for safely resuming a planned path upon completing the stop at the safe location.

19. The non-transitory computer readable storage medium of claim 14, wherein the map change includes a change of a stop sign when an intersection lane changes from uncontrolled to stop sign controlled, or from traffic light controlled to stop sign controlled, or a change of a traffic light when an intersection lane changes from uncontrolled to traffic light controlled, or from stop sign controlled to traffic light controlled.

20. The non-transitory computer readable storage medium of claim 14, wherein the map change includes a modified lane boundary or a modified curb.
